(19) United States
(12) Patent Application Publication
(10) Pub. No.: US 2017/0138528 A1
(43) Pub. Date: May 18, 2017

(54) LEVELLING DEVICE WITH DIVIDED SPINDLE AND USE

(71) Applicant: NGI A/S, Nørresundby (DK)

(72) Inventor: Morten Nyborg SORENSEN, Nørresundby (DK)

(21) Appl. No.: 15/319,973

(22) PCT Filed: Jun. 8, 2015
(86) PCT No.: PCT/DK2015/050147

§ 371 Date: Dec. 19, 2016

(30) Foreign Application Priority Data
Jun. 30, 2014 (DK) PA 2014 00347

(51) Int. Cl. F16M 7/00; A47B 91/02

(52) U.S. Cl. CPC F16M 7/00; A47B 91/024

(57) ABSTRACT

The invention includes a levelling device, which includes a top part and a lower part where there in the top part includes a spindle, which includes a thread and an external cylindrical surface and a sleeve with at least one internal stop surface, and that the spindle includes at least two separate spindle items and at least one stop surface. With the invention, it is achieved that it is possible to manufacture a levelling device, where the sleeve, as a result of the stop surface on the sleeve and the stop surface on the several part spindle cannot be screwed so high up that parts of the thread on the spindle are exposed.

### CROSS-REFERENCE TO RELATED APPLICATIONS

This application is a U.S. national stage of International Appl. No. PCT/DK2015/050147 filed 8 Jun. 2015, which claimed priority to Danish Appl. No. PA 2014 00347 filed 30 Jun. 2014, which applications are all incorporated herein by reference in their entireties.

### TECHNICAL FIELD

The invention relates to a levelling device for levelling and support of items, such as machines, which levelling device includes a top part for fastening in the item and a lower part for contact against a base, such as a floor, and where there in the top part is included a spindle, which includes a thread, a lower end surface at the lower part and an external cylindrical surface between the thread and the lower end surface, which top part also includes a sleeve, which includes a first end surface closest to the lower part and another end surface in the opposite end of the sleeve, and an internal thread in an area at the other end surface and designed to go in mesh with the thread on the spindle, which sleeve additionally includes an internal cylindrical surface between the internal thread and the first end surface with a larger circumference than the outer circumference of the spindle's thread.

Moreover, the invention relates to the use of the levelling device.

### BACKGROUND

On existing levelling devices for use in locations with high requirements for hygiene and with spindles above a certain diameter, is today typically used a sleeve, which is mounted from above around the spindle to shield the thread on the spindle.

Sleeve in this connection technically describes a thread shielding.

The sleeve is mounted from above, since the sleeve is typically mounted after the top part being connected with the lower part.

The sleeve could also be mounted from below if it occurs before the top part is connected to the lower part.

The thread on the spindle must be covered with a shielding, since cleaning a thread with small edges and sharp corners is very difficult. It is furthermore a requirement that the thread on the spindle is shielded in connection with achieving authority approvals of the levelling device, including USDA, EHEDG and 3-A approvals.

This sleeve seals with a lower sealing item lowermost towards the spindle under the spindle's thread and uppermost with an upper sealing item towards the underside of an item, such as a machine, which is to be supported by the levelling device, such that there can not enter filth and bacteria into the thread on the spindle.

It will be described in a mounting instruction that one must not screw the sleeve so high up that the lowermost part of the thread on the spindle becomes visible.

There are, however, certain drawbacks of the known technology, including that it is possible to screw the sleeve so far up that the lowermost sealing item is led with the sleeve up over the thread on the spindle and the thread on the spindle is hereby partially exposed and filth and bacteria can enter into the thread and also up under the sleeve since the lowermost sealing item can not seal against the thread itself on the spindle. This occurs despite it being described in the mounting instruction that the sleeve must not be screwed so high up.

Furthermore, it is expected that the authority approvals of the levelling device, including at USDA, will require that neither the whole thread nor parts of the thread on the spindle can be exposed by a potential faulty use.

CH698093 concerns a levelling device as described in the introduction. The levelling device, according to this document, does not appear to ensure against that the spindle's thread can be exposed by the sleeve being screwed too high up.

### SUMMARY OF THE INVENTION

It is therefore an object of the invention to show a levelling device without the above mentioned drawbacks or at least provide a useful alternative.

The object of the invention is achieved by a levelling device including a top part for fastening in an item, such as a machine, and a lower part for contact against a base, such as a floor, and where there in the top part is included a spindle, which includes a thread, a lower end surface at the lower part and an external cylindrical surface between the thread and the lower end surface, which top part also includes a sleeve, which includes a first end surface closest to the lower part and another end surface in the opposite end of the sleeve, and an internal thread in an area at the other end surface and designed to go in mesh with the thread on the spindle, which sleeve additionally includes an internal cylindrical surface between the internal thread and the first end surface with a larger circumference than the outer circumference of the spindle's thread, where the sleeve includes at least one internal stop surface, proceeding preferably perpendicular to the spindle's center axis and placed between the internal thread and first end surface on the sleeve and by the spindle furthermore including at least two separate spindle items, an upper thread part including the thread and a lower base part including the lower end surface, which spindle items include locking items for providing a cohesive spindle and that the upper thread part has a stop surface proceeding preferably perpendicular on the center axis and placed between the thread and the lower end surface.

In this way it thus becomes possible to manufacture a levelling device where the sleeve can not be screwed so high up that the whole or parts of the lowermost of the spindle's thread are exposed. Furthermore, it can be ensured that there will always be thread in the top of the spindle to fix in the item, which is to be supported.

By dividing the spindle into two separate spindle items, it is achieved that there can be provided a stop surface on the spindle, which the sleeve's stop surface can not pass past, when the sleeve is screwed up.

The stop surface on the spindle is thus placed on the upper thread part, which the sleeve is mounted on, from below, whereafter the lower base part is joined with the upper thread part in order to consist an assembled spindle.

The levelling device, which with its other construction details can be used in locations with high requirements for hygiene, can thus in the future also be approved at USDA, 3A and EHEDG if it is implemented as a requirement at the specific authorities that the spindle's thread can not be exposed by screwing the sleeve too high up.

By constructing stop surfaces as indicated on both the spindle and on the sleeve, an upper stop is provided for the sleeve's movement and it is hereby ensured that the whole or parts of the thread on the spindle are not exposed by a mistake.

Levelling device in this context includes an adjustable construction element, including an adjustable machine foot to support machines.

The levelling device can also include an adjustable leg, which supports a machine.

The adjustment of the device entails that the, on the device resting machine, can be adjusted level or in a desired angle depending on the conditions.

Further preferred embodiments of the levelling device are stated herein.

By an additional aspect of the invention, the levelling device includes that the locking items include an upper end surface on the lower base part placed in the opposite end in relation to the lower end surface proceeding preferably perpendicular on the center axis designed to form contact with a lower contact surface on the upper thread part placed between the spindle's thread and the lower end surface and proceeding preferably perpendicular to the center axis and that the locking items additionally include a hole in the lower base part, around the center axis centered, which hole emanates from the upper end surface and designed to form contact with a rod element on the upper thread part oriented along the center axis, which rod element emanates from the upper thread part's lower contact surface in direction towards the spindle's lower end surface.

It is hereby achieved that the lower base part can support the upper thread part and that the upper thread part and the lower base part are centered around the same center axis.

By an additional aspect of the invention, the levelling device includes that the rod element on the spindle's upper thread part includes an area near the lower contact surface with a non circular cross section circumference perpendicular on the center axis including external surfaces preferably parallel to the center axis and that the hole in the lower base part includes an area near the upper end surface including surfaces, which are designed to be shape complementary and form contact with the surfaces on the upper thread part.

It is hereby achieved that the upper thread part and the lower base part can be locked in rotation in relation to each other around the center axis and transfer the rotation forces from the lower base part to the upper thread part.

By an additional aspect of the invention, the levelling device includes that the spindle furthermore includes a thread rod and a lower tap part, which thread rod is designed to go in mesh with a thread hole including an inner thread, which thread hole emanates from a lower end surface on the thread part, which lower end surface limits the thread part in direction towards the spindle's lower end surface and which thread rod is designed to go in mesh with an inner thread in another thread hole, which emanates from an upper contact surface on the lower tap part, which upper contact surface is designed to form contact with a lower contact surface on the lower base part, which includes a through-going hole designed to enclose the thread rod.

It is hereby achieved that the upper thread part, the lower base part and the lower tap part can be screwed together with the thread rod and thereby ensured that the upper thread part can not be pulled from the lower base part.

By an additional aspect of the invention, the levelling device includes that the rod element on the spindle includes an external cylindrical surface designed to form contact with an internal cylindrical surface in the lower base part. It is hereby achieved that the thread part and the base part are controlled, in relation to each other, around the center axis.

By an additional aspect of the invention, the levelling device includes that the lower contact surface on the spindle's upper thread part is identical to the stop surface on the upper thread part.

It is hereby achieved that the external geometry on the upper thread part can be used efficiently.

By an additional aspect of the invention, the levelling device includes that the stop surface on the spindle is limited by the spindle's external cylindrical surface and the outer circumference of the spindle's thread.

It is hereby achieved that the spindle's stop surface has an extent, which causes that it forms stop for the sleeve's stop surface.

By an additional aspect of the invention, the levelling device includes that the internal stop surface on the sleeve is limited by the internal cylindrical surface and another surface placed between the spindle's external cylindrical surface and the outer circumference of the spindle's thread. It is hereby achieved that the sleeve's stop surface has an extent, which causes that it forms stop for the spindle's stop surface.

By an additional aspect of the invention, the levelling device includes that the stop surface is plane and proceeding perpendicular or in a slanted angle with the spindle's center axis.

By an additional aspect of the invention, the levelling device includes that the sleeve includes a ledge including a surface for providing the stop surface.

By an additional aspect of the invention, the levelling device includes that the lower base part includes a surface with a larger circumference in a plane perpendicular to the spindle's center axis than the circumference of the cylindrical surface on the spindle.

It is hereby achieved that the lower end surface has a size which allows sufficient support and sealing towards the lower part.

As mentioned, the invention also relates to use of the above mentioned levelling device in locations with high requirements for hygiene such as locations for processing of foodstuffs or manufacturing of medicine.

The invention also relates to use of a levelling device, according to the above described, for support of a machine placed in areas with risk of earthquake.

### BRIEF DESCRIPTION OF THE DRAWINGS

The invention will now be explained more fully with reference to the drawings, on which:

FIG. 1 shows an assembled levelling device according to the invention.

FIG. 2 shows an assembled top part according to the invention

FIG. 3 shows an exploded drawing of a first embodiment of the top part shown in FIG. 2

FIG. 4 shows a cut through the top part in the first embodiment along the line B-B shown in FIG. 3

FIG. 5 shows an exploded drawing of another embodiment of the top part shown in FIG. 2

FIG. 6 shows a cut through the top part in the other embodiment along the line B-B shown in FIG. 5

FIG. 7 shows an exploded drawing of a third embodiment of the top part shown in FIG. 2

FIG. 8 shows a cut through the top part in the third embodiment along the line B-B shown in FIG. 7

### DETAILED DESCRIPTION OF THE INVENTION

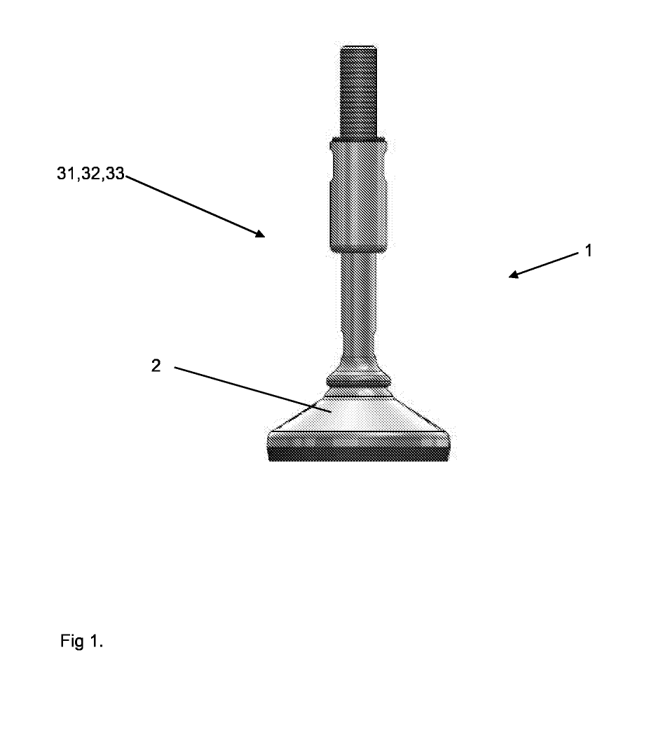

FIG. 1 shows a levelling device 1 including a top part 31,32,33 and a lower part 2. The top part 31,32,33 is typically fixed to a machine while the lower part 2 is the support towards a base. The top part 31,32,33 includes a spindle 41,42,43 and a mounted sleeve 6, around the spindle 41,42,43. The spindle 41,42,43 is in the upper part closest to the machine provided with a thread 91,92,93

According to the invention and the figures, there is shown 3 different embodiments of the spindle 41,42,43. A first and preferred embodiment, which is described by the spindle 41, another embodiment, which is described by the spindle 42 and a third embodiment, which is described by the spindle 43.

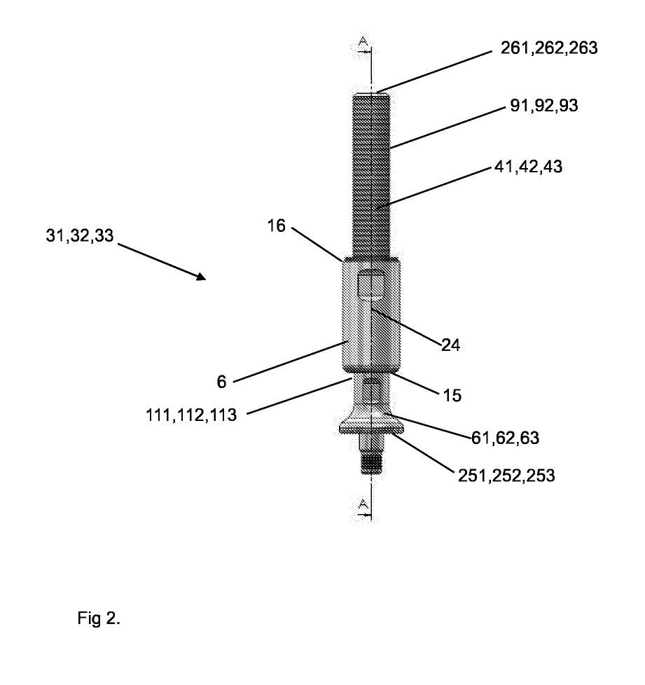

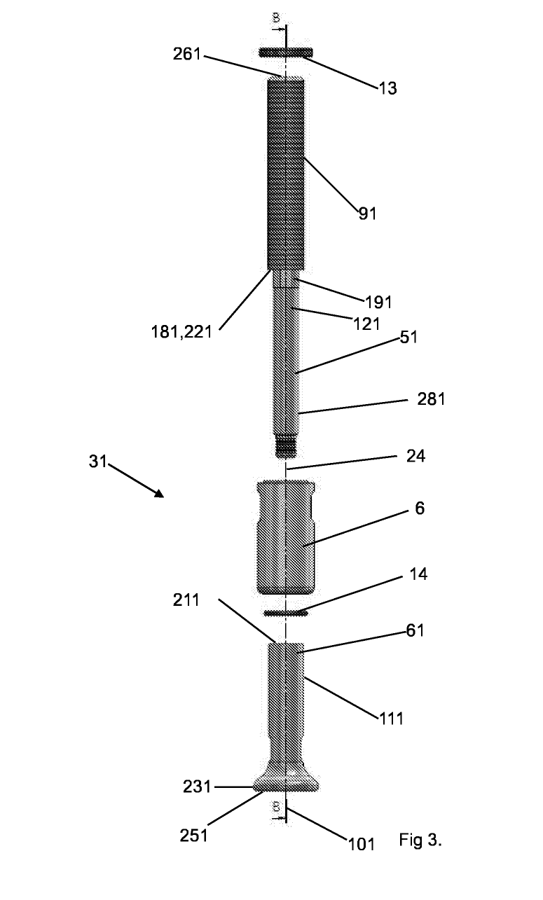

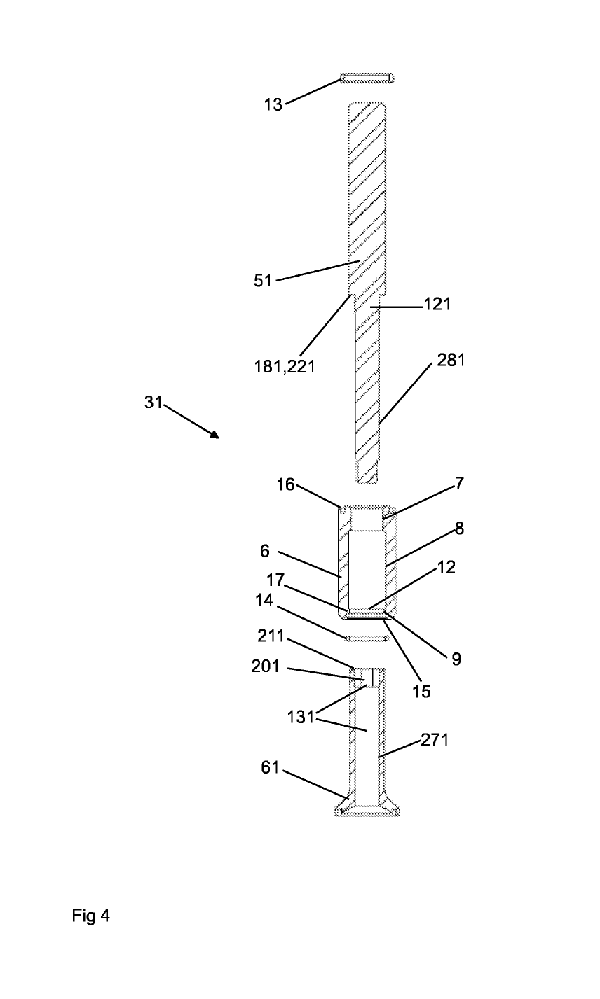

The top part 31,32,33 and the joint characteristics for the three described embodiments of the spindle 41,42,43 will hereafter be described more fully with reference to FIG. 2, FIG. 3 and FIG. 4, where FIG. 4 is a sectional view of the in FIG. 3 stated along the line BB.

The spindle 41,42,43 is upwards limited by an upper end surface 261,262,263 and opposite this by a lower end surface 251,252,253.

Closest to the upper end surface 261,262,263, the spindle is provided with the thread 91,92,93. The spindle 41,42,43 is a rod shaped cylindrical item around which the sleeve 6 is placed. The sleeve 6 is likewise a cylindrical item including an upper end surface 16 closest to the spindle's 41,42,43 upper end surface 261,262,263 and an opposite placed and limiting lower end surface 15 closest to the spindle's 41,42,43 lower end surface 251,252,253.

In FIG. 2 is shown that the cylindrical spindle 41,42,43 has a center axis 24 and in FIG. 3 is with 101 marked a line BB, which states the cut, which is depicted in FIG. 4.

The top part 31,32,33 furthermore includes an upper sealing item 13 and a lower sealing item 14.

The upper sealing item 13 is mounted on the sleeve 6 in the area at the sleeve's 6 upper end surface 16 and is designed to seal between the machine, which is to be supported and the sleeve 6 such that there can not enter filth and bacteria into the spindle's 41,42,43 thread 91,92,93 in this area. The lower sealing 14 is mounted on the sleeve 6 in the area at the sleeve's 6 lower end surface 15 and is designed to seal between the external cylindrical surface 111,112,113 on the spindle 41,42,43 and the sleeve 6, such that there can not enter filth and bacteria into the spindle's 41,42,43 thread 91,92,93 in this area.

The sleeve 6 where the internal details are shown in the sectional view FIG. 4, includes an internal thread 7 placed in the area closest to the upper end surface 16 on the sleeve 6.

This thread 7 is designed to go in mesh with the spindle's 41,42,43 thread 91,92,93.

In the sleeve 6 there is an internal cylindrical surface 8, as shown on FIG. 4. This cylindrical surface 8 has a circumference, which is larger than the outer circumference on the spindle's 41,42,43 thread 91,92,93 such that the cylindrical surface 8 can be led up around the thread 91,92,93 on the spindle 41,42,43 when the sleeve 6 with the internal thread 7 is screwed up on the spindle's 41,42,43 thread 91,92,93.

The cylindrical surface 8 is placed between the thread 7 and the lower end surface 15 on the sleeve 6.

The surface 8 is in a preferred embodiment cylindrical, but can also have a non cylindrical cross sectional circumference in a plane perpendicular to the center axis 24, including consisting of several plane surfaces.

In the sleeve 6, there is furthermore another internal surface 9, which is shown on FIG. 4, which is placed between the spindle's 41,42,43 external cylindrical surface 111,112,113 and the outer circumference on the spindle's 41,42,43 thread 91,92,93. The surface 9 is in a preferred embodiment cylindrical, but can also have a non cylindrical cross sectional circumference in a plane perpendicular to the center axis 24, including consisting of several plane surfaces.

In the sleeve 6 there is furthermore a stop surface 12, which is shown on FIG. 4, which is limited by the internal cylindrical surface 8 and the other surface 9. The stop surface 12 is here shown as a disc shaped surface on the sleeve 6 between the two surfaces 8,9.

The stop surface 12 is in a preferred embodiment plane and proceeding perpendicular to the spindle's 41,42,42 center axis 24, but is not limited to this orientation and shape, including can also be slanted in relation to the center axis 24 or consist of several separate surfaces.

The stop surface 12 on the sleeve 6 is also, in a preferred embodiment, placed so close to the lower end surface 15 on the sleeve 6 as possible, such that the distance between this stop surface 12 and a stop surface 181,182,183 on the spindle 41,42,43 placed where the spindle's 41,42,43 thread 91,92,93 is limited in direction towards the lower end surface 251,252,253 is as large as possible when screwing on of the sleeve 6 is initiated such that the sleeve 6 can be screwed as far as possible up over the thread 91,92,93 on the spindle 41,42,43.

On the sleeve 6 in the area at the lower end surface 15 there is a ledge 17, shown in FIG. 4, which is limited by the internal cylindrical surface 8 and the other internal surface 9 on the sleeve 6. This ledge 17 has an internal side/surface, proceeding preferably perpendicular to the spindle's 41,42,43 center axis 24, which includes the stop surface 12.

This ledge 17 in a preferred embodiment also provides support for the lower sealing item 14.

In an alternative embodiment, this ledge 17 can, on the sleeve 6, which with its internal side consists the stop surface 12, be placed in a larger distance from the first end surface 15 and thereby the sleeve's 6 possibility of movement upward will be reduced since the distance between the stop surface 12 on the sleeve 6 and the stop surface 181,182,183 on the spindle 41,42,43 is reduced. The support of the lower sealing item 14 will thus possibly have to consist of another element on the sleeve 6.

The lower sealing item 14 will typically be an O-ring, but is not limited to this and can in an alternative embodiment have other designs, including be a cylindrical ring shaped item.

The spindle 41,42,43 includes at least two parts, including an upper thread part 51,52,53 and a lower base part 61,62,63.

A first embodiment of the spindle 41 in the top part 31 will hereafter be described more fully with reference to FIG. 3 and FIG. 4, where top part 31 is shown. The spindle 41 is furthermore shown assembled in FIG. 2.

In the first and preferred embodiment, the upper thread part 51 includes the spindle's 41 thread 91 and a preferably cylindrical rod element 121, which is designed to reach through the lower preferably cylindrical and ring shaped base part 61. At the transition between the thread 91 and the rod element 121 is found a stop surface 181 proceeding perpendicular on the center axis 24 and an area with a non circular cross sectional circumference in a plane perpendicular on the center axis 24 on the rod element 121, which includes external surfaces 191 preferably parallel to the center axis 24, designed to form contact with shape complementary internal surfaces 201, also preferably parallel to the center axis 24 on the lower base part 61 and placed in the area at the upper end surface 211 in a hole 131, which emanates from the upper end surface 211, centered around the center axis 24 such that the upper thread part 51 and the lower base part 61 are locked in rotation in relation to each other around the center axis 24 and there can thereby be transferred rotational forces from the lower base part 61 to the upper thread part 51.

The base part 61 is limited upwards by an upper end surface 211, which forms contact against the stop surface 181 on the upper thread part 51, which is thereby identical to a lower contact surface 221 on the upper thread part 51. The stop surface 181 is thus also a lower contact surface 221 for the base part's 61 upper end surface 211. Furthermore, the base part 61 has an internal cylindrical surface 271 in the hole 131, which is designed to be shaped complementary with an external cylindrical surface 281 on the upper thread part 51, such that the two parts 51,61 are controlled mechanically and have the same center axis 24. The transition between the external cylindrical surface 281 and the surfaces 191 on the upper thread part 51 are placed between the spindle's 41 stop surface 181 and the lower end surface 251.

The spindle's 41 thread 91 on the upper thread part 51 is thus in direction towards the lower end surface 251 on the spindle 41 limited by the stop surface 181. The external cylindrical surface 111 proceeds from the stop surface 181 and in direction towards the lower end surface 251 on the spindle 41, where the cylindrical surface 111 in the area at the lower end surface 251 on the spindle 41 proceeds over in a surface 231 with a larger circumference.

The circumference of this cylindrical surface 111 on the spindle 41 is smaller than the outer circumference on the spindle's 41 thread 91. This difference in diameters is used to provide the stop surface 181, which is thus limited by the spindle's 41 cylindrical surface 111 and outer circumference on the spindle's 41 thread 91.

On the lower part of the cylindrical surface 111, there are two parallel plane surfaces on each side of the center axis 24. These surfaces are used for contact for a screw wrench, such that it is possible to turn the spindle or to hold it fixed.

The cylindrical surface 111 is smooth, with which there is understood that the surface is without thread and suited for forming contact for the lower sealing item 14.

The stop surface 181 is in this first embodiment placed where the thread 91 and the cylindrical surface 111 on the spindle 41 meet, but can also be placed further down in direction towards the lower end surface 251 on the spindle 41.

The stop surface 191 is here shown perpendicular to the center axis 24, but can also have other designs, including being inclined in relation to the center axis 24 and is thus not limited to the plane surface shown here.

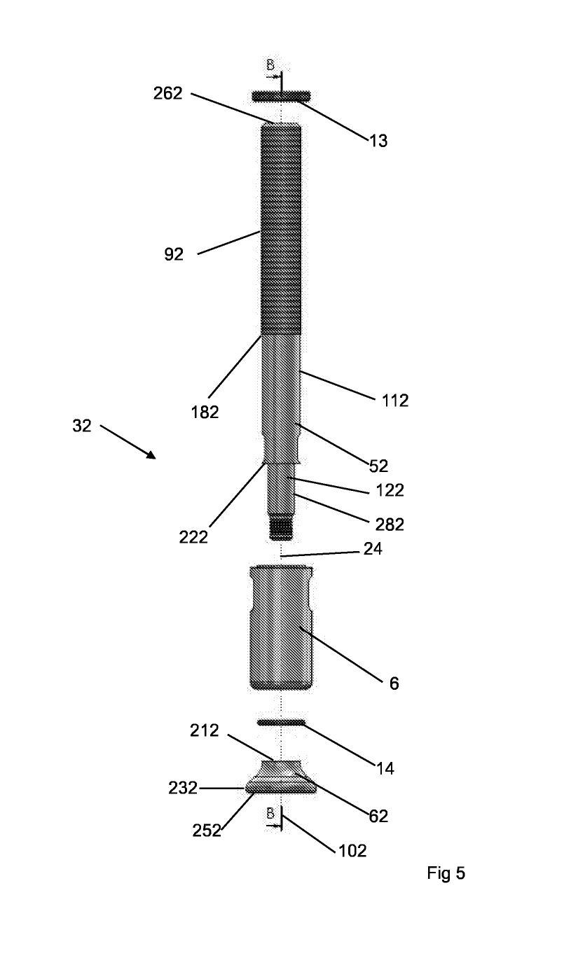

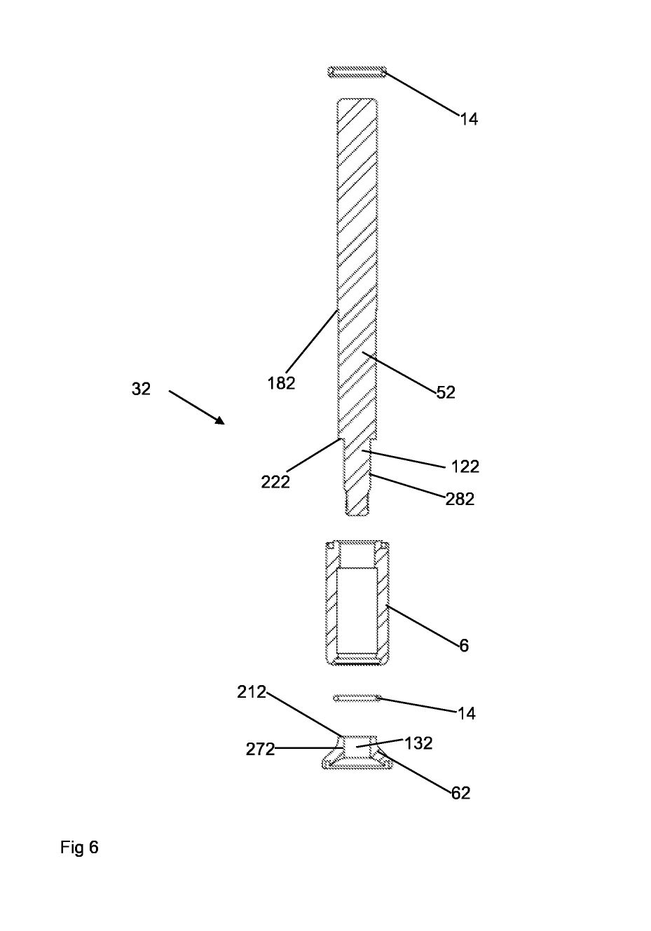

Another embodiment of the spindle 42 will in top part 32 hereafter be described more fully with reference to FIG. 5 and FIG. 6, where top part 32 is shown. The spindle 42 is furthermore shown assembled in FIG. 2.

In the other embodiment, the spindle 42 is likewise split in an upper thread part 52 and a lower base part 62.

In relation to the first embodiment, the connection between the upper thread part 52 and the lower base part 62 is moved down towards the spindle's 42 lower end surface 252 such that the upper end surface 212 on the base part 52 forms contact towards a lower contact surface 222 on the upper thread part 52, which is not identical to the stop surface 182.

The lower contact surface 222 is thus placed between the spindle's 42 stop surface 182 and the lower end surface 252.

From the lower contact surface 222 in direction away from the thread 92 is found a rod element 122.

The stop surface 182 is limited by the spindle's 42 cylindrical surface 112 and outer circumference of the spindle's 42 thread 92 and is placed where the thread 92 and the external cylindrical surface 112 meet on the spindle 42.

The external cylindrical surface 112, which is designed to seal against the lower sealing item 14, is here placed on the upper thread part 52. The lower contact surface 222 on the upper thread part 52 occurs at the transition between the external cylindrical surface 112 and a cylindrical surface 282 with a smaller diameter on the rod element 92. The cylindrical surface 282 is furthermore designed to be shape complementary with an internal cylindrical surface 272 in a hole 132, which emanates from the upper end surface 212, centered around the center axis 24 in the lower base part 62.

The lower base part 62 and the upper thread part 52 are not locked in rotation in relation to each other around the center axis 24 in this embodiment and there can thereby not be transferred rotational forces between the upper thread part 52 and the lower base part 62. The joining between the lower base part 62 and the upper thread part 52, which is shaped by the contact between the surfaces 212 and 222, is not hidden below the sleeve 6 and can be closed with a washer or glue, in order to be approved for use in locations with high requirements for hygiene.

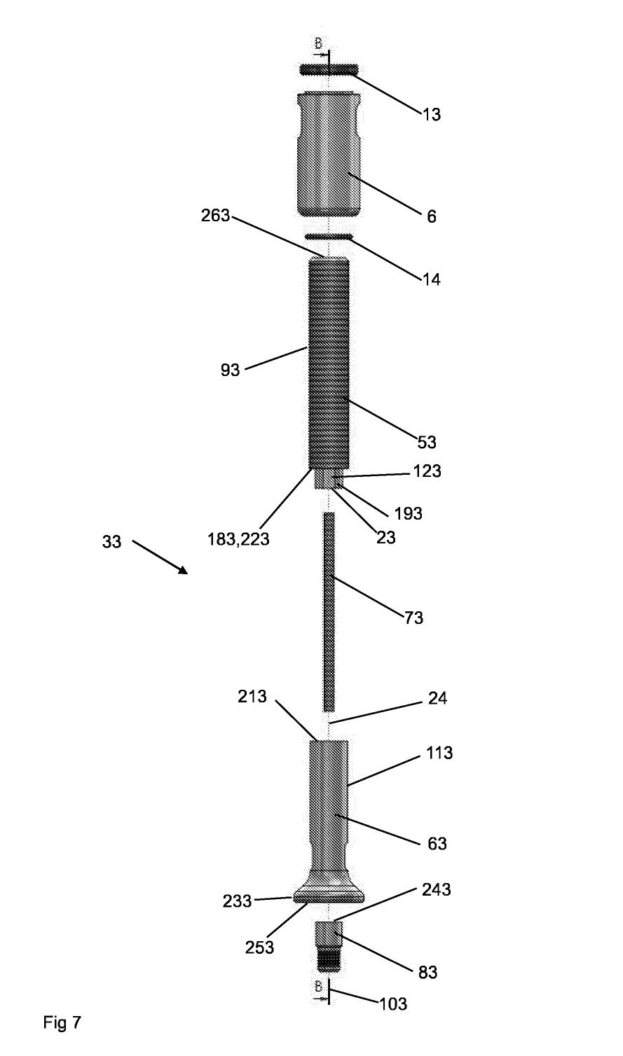

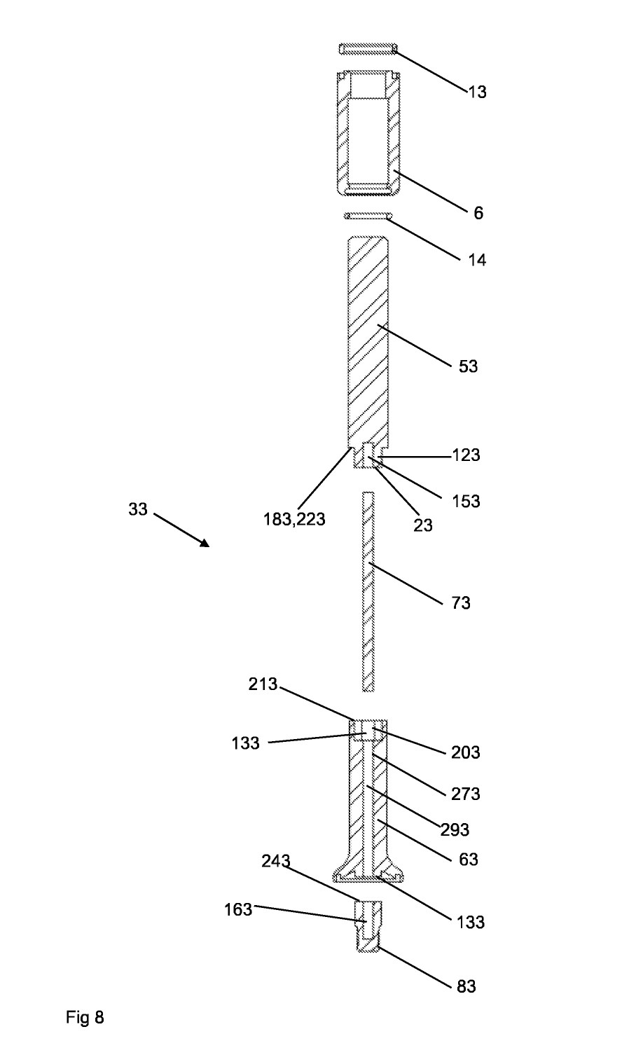

A third embodiment of the spindle 43 in top part 33 will hereafter be described more fully with reference to FIG. 7 and FIG. 8, where top part 33 is shown. The spindle 43 is also shown assembled in FIG. 2.

In the third embodiment, the spindle 43 is divided in an upper thread part 53, a lower base part 63, a thread rod 73 and a lower tap part 83. As in the first embodiment, an upper end surface 213 on the lower base part 63 forms contact with the stop surface 183, which is thereby identical to a lower contact surface 223 on the upper thread part 53. The stop surface 183 on the upper thread part 53 is thus also lower contact surface 223 for an upper end surface 213 on the lower base part 63. From the lower contact surface 223 on the upper thread part 53 emanates the rod element 123 with a non circular cross sectional circumference perpendicular on the center axis 24, on which there is found external surfaces 193, which are designed to form contact with shape complementary internal surfaces 203, likewise preferably parallel to the center axis 24 on the base part 63 and placed in the area at the upper end surface 213 in a hole 133, which emanates from the upper end surface 213, centered around the center axis 24, such that the thread part 53 and the base part 63 are locked in rotation in relation to each other around the center axis 24.

The external cylindrical surface 113, which is designed to seal against the lower sealing item 14 is here placed on the lower base part 63.

The upper thread part 53 is limited downwards by an end surface 23, which likewise limits the area with the external surfaces 193, which are designed to form contact with the internal surfaces 203 on the base part 63. There is thus not found a cylindrical area on the rod element 123 on the upper thread part 53.

From the lower end surface 23 and up in the upper thread part 53 is found a thread hole 153 around the center axis 24 with an inner thread, designed to go in mesh with a thread rod 73.

The thread rod 73, which is designed to, with the one end, be screwed fixed in the thread hole 153 in the upper thread part 63, goes through a hole 193 with an internal cylindrical surface 273 in the lower base part and is screwed on with the other end in the lower tap part 83, in which there is found a thread hole 163 with an inner thread, designed to go in mesh with the thread rod 73. The thread hole 163 in the lower tap part 83 emanates from the upper end surface 43, which is designed to form contact with a lower contact surface 133 on the lower base part 63.

The lower base part 63 is thereby fixed between the upper thread part 53 and the lower tap part 83 and the four parts 53,63,73,83 consist an assembled spindle 43, where the upper thread part 52 and the lower base part 63 can not be pulled from each other.

The sleeve 6, the center axis 24, the upper sealing item 13 and the lower sealing item 14 are in all the shown embodiments identical.

In the shown embodiments, the stop surface 181,182,183 is placed where the thread 91,92,93 and the cylindrical surface 111,112,113 on the spindle 41,42,43 meet, but can also be placed further down in direction towards the lower end surface 251,252,253 on the spindle 41,42,43.

The stop surface 181,182,183 is here shown perpendicular to the center axis 24, but can also have other designs, including being inclined in relation to the center axis 24 and is thus not limited to the plane surface shown here.

In the spindle 41 and 42, the upper thread part 51,53 is locked in rotation in relation to the lower base part 61,63 by the surfaces 191,193 on the upper thread part 51,53 forming contact with the surfaces 201, 203 on the lower base part 61,63 such that it is thereby possible to turn the spindle's 41,43 thread 91,93 on the upper thread part 51,53 by turning the lower base part 61,63, which is designed with surfaces for being able to form contact with a screw wrench. In the spindle 42, the surfaces for contact with a screw wrench are placed on the upper thread part 42, wherefore the upper thread part 52 and the lower base part 62 in spindle 42 are not locked in rotation around the center axis 24 in relation to each other.

In the spindle 41 and 43, the external surfaces 191,193 on the upper thread part 51,53 and the external surfaces 201,203 on the lower base part 61,63 are shown preferably parallel to the center axis, but they are not limited to this orientation and can have other orientations including being slanted in relation to the center axis 24.

The spindle 41,42,43 is not limited to the designs shown here including having a surface 231,232,233 with a larger circumference at the lower end surface 251,252,253, but can in another embodiment by designed for the cylindrical surface 111,112,113 on the spindle being limited downwards by the lower end surface 251,252,253 on the spindle and thereby defines the largest circumference on the spindle 41,42,43 between the spindle's 41,42,43 thread 91,92,93 and the lower end surface 251,252,253. Hereby, the sleeve 6 can alternatively be mounted from below before the top part 31,32,33 is connected with the lower part 2.

The connection between the upper thread part 51,52,53 and the lower base part 61,62,63 in the spindle 41,42,43 is not limited to the designs shown here, but can have other embodiments, including an embodiment including a thread piece with an external thread, which emanates from the lower base part's 61,62,63 upper end surface 211,212,213, designed to go in mesh with an inner thread in a thread hole, which emanates from the lower contact surface 221,222,223 on the upper thread part 51,52,53.

In a levelling device 1, according to the invention, it is not possible to expose the whole or parts of the lowermost of the spindle's 41,42,43 thread 91,92,93 by a mistake, when the sleeve 6 is screwed up in order to seal against the item, which is to be supported, since there by adding stop surfaces 181,182,183 on the several part spindle 41,42,43 and a stop surface 12 in the sleeve 6 is provided an upper stop for the sleeve's 6 movement.

Thereby, the expected future requirements from the authorities can be met and the authority approvals, including from USDA, are achieved.

It is a part of the invention that the described levelling device 1 is used in locations with high requirements for hygiene such as locations for processing of foodstuffs or manufacturing of medicine.

1.-13. (canceled)

14. A levelling device for levelling and support of an item, comprising:
a top part for fastening in the item and having a spindle, and
a lower part for contact against a base and having a sleeve,
wherein the spindle comprises a thread, a lower end surface at the lower part, and an external cylindrical surface between the thread and the lower end surface,
wherein the sleeve comprises a first end surface closest to the lower part and another end surface in the opposite end of the sleeve, and an internal thread in an area at the other end surface and designed to go in mesh with the thread on the spindle,
wherein the sleeve further comprises an internal cylindrical surface between the internal thread and the first end surface having a larger circumference than the outer circumference of the thread of the spindle,
wherein the sleeve further comprises at least one internal stop surface, proceeding at least substantially perpendicular to the center axis of the spindle, and placed between the internal thread and first end surface on the sleeve,
wherein the spindle further comprises at least two separate spindle items comprised of an upper thread part including the thread, and a lower base part including the lower end surface, and
wherein the spindle items comprise locking items for providing a cohesive spindle, and the upper thread part having a stop surface proceeding preferably perpendicular on the center axis and placed between the thread and the lower end surface.

15. The levelling device according to claim 14, wherein the locking items comprise an upper end surface on the lower base part placed in the opposite end in relation to the lower end surface proceeding at least substantially perpendicular on the center axis designed to form contact with a lower contact surface on the upper thread part placed between the thread of the spindle and the lower end surface and proceeding at least substantially perpendicular to the center axis,
wherein the locking items further comprise a hole around the center axis centered in the lower base part,
wherein the hole emanates from the upper end surface and is configured to form contact with a rod element on the upper thread part oriented along the center axis, and
wherein the rod element emanates from the lower contact surface of the upper thread part in a direction towards the lower end surface of the spindle.

16. The levelling device according to claim 15, wherein the rod element on the upper thread part of the spindle comprises an area near the lower contact surface with a non-circular cross section circumference perpendicular on the center axis including external surfaces at least substantially parallel to the center axis, and
wherein the hole in the lower base part includes an area near the upper end surface including surfaces configured to be shaped complementary and form contact with the surfaces on the upper thread part.

17. The levelling device according to claim 14, wherein the spindle further comprises a thread rod and a lower tap part, wherein the thread rod is designed to go in mesh with a thread hole including an inner thread, wherein the thread hole emanates from a lower end surface the thread part, wherein the lower end surface limits the thread part in a direction towards the lower end surface of the spindle, wherein the thread rod is designed to go in mesh with an inner thread in another thread hole, which emanates from an upper contact surface on the lower tap part, wherein the upper contact surface is configured to form contact with a lower contact surface on the lower base part, which comprises a through-going hole configured to enclose the thread rod.

18. The levelling device according to claim 15, wherein the rod element on the spindle comprises an external cylindrical surface configured to form contact with an internal cylindrical surface in the lower base part.

19. The levelling device according to claim 15, wherein the lower contact surface on the upper thread part of the spindle is identical to the stop surface on the upper thread part.

20. The levelling device according to claim 14, wherein the stop surface on the spindle is limited by the external cylindrical surface of the spindle and the outer circumference of the thread of the spindle.

21. The levelling device according to claim 14, wherein the internal stop surface on the sleeve is limited by the internal cylindrical surface and another surface positioned between the external cylindrical surface of the spindle and the outer circumference of the thread of the spindle.

22. The levelling device according to claim 14, wherein the stop surface is level and proceeding perpendicular or in a slanted angle with the center axis of the spindle.

23. The levelling device according to claim 14, wherein the sleeve comprises a ledge having a surface configured to provide the stop surface.

24. The levelling device according to claim 14, wherein the lower base part comprises a surface with a larger circumference in a plane perpendicular to the center axis of the spindle than the circumference of the cylindrical surface on the spindle.

25. Use of levelling device according to claim 14 in locations with high requirements for hygiene such as locations for processing of foodstuffs or manufacturing of medicine.

26. Use of a levelling device according to claim 14 for support of a machine placed in areas with risk of earthquake.
